(19) United States
(12) Patent Application Publication
(10) Pub. No.: US 2024/0057552 A1
(43) Pub. Date: Feb. 22, 2024

(54) PET WATER DISPENSER AND FILTER

(71) Applicant: Qingdao Ecopure Filter Co., Ltd., Qingdao (CN)

(72) Inventor: Zhibin Zou, Qingdao (CN)

(73) Assignee: Qingdao Ecopure Filter Co., Ltd., Qingdao (CN)

(21) Appl. No.: 18/452,125

(22) Filed: Aug. 18, 2023

(30) Foreign Application Priority Data
Aug. 18, 2022 (CN) 202222174353.6
Nov. 8, 2022 (CN) 202222962845.1

(51) Int. Cl. A01K 7/02; B01D 35/30; B01D 35/02

(52) U.S. Cl. CPC A01K 7/025; B01D 35/30; B01D 35/02

(57) ABSTRACT

A filter assembly includes an end cover configured to connect with the water dispenser, and a filter housing assembled with the end cover and comprising a cavity configured to receive a filtering material. The end cover includes a body portion and a mounting portion protruding from the body portion. The mounting portion is configured to releasably attach to the water dispenser and has an oval or oval-like cross-section in a horizontal plane, and both ends of the oval or oval-like cross-section are inwardly recessed. Also described is filter assembly including at least one seal having an oval or oval-like cross-section in a horizontal plane, wherein both ends of the oval or oval-like cross-section are inwardly recessed, and wherein the at least one seal is configured to create a water-tight seal between the mounting portion and the water dispenser. A water dispenser for use with the filter assemblies is also described.

### CROSS-REFERENCE TO RELATED APPLICATIONS

This application claims priority to Chinese Patent Application No. 202222962845.1, filed Nov. 8, 2022, and Chinese Patent Application No. 202222174353.6, filed Aug. 18, 2022, each of which is hereby incorporated by reference in its entirety.

### TECHNICAL FIELD

This application generally relates to a pet water dispenser and, in particular to a pet water dispenser with water filtering capabilities.

### BACKGROUND

Pet water feeders are used by many pet owners to provide drinking water for their pets. If the water is not changed regularly and/or if the feeder is not cleaned regularly, bacteria and microorganisms can flourish rendering the drinking water unsanitary. For example, mold spores that attach to pets in the outdoor air can fall into drinking trays or water tanks, and breed. The mold can cause health problems in pets, and exposure to mold may cause respiratory and digestive symptoms.

To address potential water quality issues, pet water feeders with filtering functions have appeared on the market. For example, Chinese patent application (CN213939283U) discloses a pet water dispenser having a water storage tank, a water return part, a drinking water tray, and a shower head. The bottom of the water storage tank is provided with a water pump that is connected with a sealing tube. The upper side of the sealing tube is connected with a water guide tube, the middle part of the drinking tray is provided with a water collecting cavity, the end of the water guide tube, away from the sealing tube, is connected to the water collecting cavity, and the shower head is connected with one end of the water guide pipe connected with the water collecting cavity. the water return part is provided with a water return groove; the water return groove is detachably connected with a filter element. The filter element includes a water filter layer connected to multiple dust collection parts. The dust collection part is in the shape of a fan structure and the water filter layer is activated carbon filter layer.

While filter element can realize the filtration of pet drinking water and improve the purity of water. However, the fan-shaped filter element in the pet water dispenser provided by the prior art is difficult to achieve good sealing performance, and water is prone to overflow along the edge of the filter element.

### SUMMARY

This summary is meant to provide some examples and is not intended to be limiting of the scope of the invention in any way. For example, any feature included in an example of this summary is not required by the claims, unless the claims explicitly recite the feature. Also, the features, components, steps, concepts, etc. described in examples in this summary and elsewhere in this disclosure can be combined in a variety of ways. Various features and steps as described elsewhere in this disclosure may be included in the examples summarized here.

According to various embodiments described herein, a filter assembly for filtering water in a water dispenser is provided. The filter assembly comprises an end cover configured to connect with the water dispenser, and a filter housing assembled with the end cover and comprising a cavity configured to receive a filtering material. The end cover includes a body portion and a mounting portion protruding from the body portion, wherein the mounting portion is configured to releasably attach to the water dispenser. The mounting portion has an oval or oval-like cross-section in a horizontal plane, and both ends of the oval or oval-like cross-section are inwardly recessed.

According to some embodiments, the filter housing further comprises an opening communicating with the cavity, wherein the end cover is arranged at the opening. In some embodiments, the end cover comprises a water inlet in fluid communication with the cavity, and forms a sealed connection with the filter housing.

According to some embodiments, the mounting portion is configured to be at least partially received within a filter connecting portion of the water dispenser.

In some embodiments, the end cover includes one or more water inlet openings, and the filter housing includes one or more water outlet openings for receiving water from the one or more water inlet openings. In some embodiments, the mounting portion of the end cover includes a top surface and wherein at least one of the water inlet openings is positioned on the top surface. In some embodiments, the top surface is concave. In some embodiments, at least one of the water inlet openings is positioned at a low point on the concave top surface.

According to some embodiments, the filter housing includes a side wall and a bottom wall and at least one of the water outlet openings is positioned on the bottom wall. In some embodiments, the one or more water outlet openings are screened or meshed.

In some embodiments shown and described herein, the mounting portion includes one or more connectors for releasably attaching to the water dispenser. In some embodiments, the one or more connectors are projections configured to be received within corresponding connecting portion on the water dispenser.

In some embodiments, each of the end walls of the mounting portion includes at least one connector for releasably attaching the end cover to the water dispenser.

According to some embodiments, an angle between an outer surface of the first inclined portion and an outer surface of the planar portion is greater than 90°. In some embodiments, the planar portion includes at least one connector for releasably attaching the end cover to the water dispenser.

In some embodiments, the mounting portion is symmetric about a central axis. In some embodiments, the filter assembly further includes a seal disposed around a circumference of the mounting portion and configured to form a seal when the filter assembly is received within a filter connecting portion of a water dispenser.

According to various embodiments, a filter assembly for filtering water in a water dispenser comprises an end cover configured to connect with the water dispenser, a filter housing assembled with the end cover forming a cavity for accommodating a filtering material, and at least one seal having an oval or oval-like cross-section in a horizontal plane. The end cover includes a body portion and a mounting portion protruding from the body portion, and the mounting portion is configured to releasably couple to the water dispenser. Both ends of the oval or oval-like cross-section of the at least one seal are inwardly recessed, and the at least one seal is configured to create a water-tight seal between the mounting portion and the water dispenser.

According to various embodiments, a water dispenser comprises a tank body defining an interior space for storing water, a top cover detachably arranged on the tank body above the interior space, and a filter assembly detachably installed in the interior space. The top cover has an upper surface that at least partially defines a drinking tray with a first water return port and a filter connecting portion extending downward below the water return port. The filter assembly comprises an end cover and a filter housing, the end cover including a body portion and a mounting portion protruding from the body portion. The mounting portion is configured to releasably attach the end cover to the filter connecting portion.

In some embodiments, the top cover further comprises a guide wall extending downward from the top cover, wherein the guide wall is disposed between the water return port and the filter connecting portion, and comprises an arcuate wall, a substantially flat wall, and a pair of side walls extending between the arcuate wall and the substantially flat wall.

In some embodiments, the filter connecting portion includes a pair of end walls connected by a pair of side walls that are symmetrical and curved, each of the end walls are inwardly recessed and includes a first inclined portion, a planar portion, and a second inclined portion sequentially connected.

### DESCRIPTION OF DRAWINGS

To further clarify various aspects of implementations of the present disclosure, a more particular description of the certain examples and implementations will be made by reference to various aspects of the appended drawings. These drawings depict only example implementations of the present disclosure and are therefore not to be considered limiting of the scope of the disclosure. Moreover, while the FIGS. can be drawn to scale for some examples, the FIGS. are not necessarily drawn to scale for all examples. Examples and other features and advantages of the present disclosure will be described and explained with additional specificity and detail through the use of the accompanying drawings in which:

FIG. 1 is a perspective view of an example pet water dispenser;

FIG. 2 is the front view of the pet water dispenser of FIG. 1;

FIG. 3 is a sectional view of the pet water dispenser of FIG. 2 taken along the A-A line;

FIG. 4 is a partial exploded view of the pet water dispenser of FIG. 1;

FIG. 5 is a side view of an example dispensing assembly for the pet water dispenser of FIG. 4;

FIG. 6 is an exploded view of the dispensing assembly of FIG. 5;

FIG. 7 is perspective view of a water storage tank and a drinking tray of the pet water dispenser of FIG. 1;

FIG. 8 is perspective view of a drinking tray and a filter element of the pet water dispenser of FIG. 1;

FIG. 9 is a partial exploded view of a drinking tray, a filter element, and a water storage tank of the pet water dispenser of FIG. 1;

FIG. 10 is a side view of a base of the pet water dispenser of FIG. 1;

FIG. 11 is a bottom view of the base of the pet water dispenser of FIG. 1;

FIG. 12 is an exploded view of the base of the pet water dispenser of FIG. 1;

FIG. 13 is partial assembled view of the pet water dispenser of FIG. 1;

FIG. 14 is rear partial assembled view of the pet water dispenser of FIG. 1;

FIG. 15 is bottom partial assembled view of the pet water dispenser of FIG. 1;

FIG. 16 is a cross-sectional view along the length direction of the water storage tank of the pet water dispenser of FIG. 1;

FIG. 17 is a cross-sectional view along the width direction of the water storage tank of the pet water dispenser of FIG. 1.

FIG. 18 is a structural representation of an example filter element for a pet water dispenser;

FIG. 19 is a structural schematic diagram of another viewing angle of the filter element provided by some embodiments of the present invention;

FIG. 20 is a schematic structural view of the filter element end cap in the filter element provided by some embodiments of the present invention;

FIG. 21 is the side view of FIG. 20;

FIG. 22 is a schematic diagram of an assembly structure of a filter element provided by some embodiments of the present invention;

FIG. 23 is a structural schematic view of a water receiving tray matched with the filter element provided in some embodiments of the present invention;

FIG. 24 is a structural schematic diagram of another viewing angle of the water receiving tray matched with the filter element provided by some embodiments of the present invention;

FIG. 25 is a schematic structural view of the end cover of the filter element in the filter element provided by some embodiments of the present invention;

FIG. 26 is a structural schematic diagram of another viewing angle of the water receiving tray matched with the filter element provided by some embodiments of the present invention

FIG. 27 is a structural representation of an example filter element for a pet water dispenser including a seal disposed about a mounting portion provided by some embodiments; and

FIG. 28 is a structural representation of an example seal and filter element for a pet water dispenser provided by some embodiments.

### DETAILED DESCRIPTION

The following description refers to the accompanying drawings, which illustrate example implementations of the present disclosure. Other implementations having different structures and operation do not depart from the scope of the present disclosure.

It should be noted that, in the description of the present application, terms such as “up”, “down”, “left”, “right”, “vertical”, “horizontal”, “inside,” and “outside” indicate directions or are terms of positional relationship that are based on the direction or positional relationship shown in the drawings, which are only for convenience of description, and do not indicate or imply that the device or element must have a specific orientation, be constructed and operated in a specific orientation, and therefore cannot be understood. In addition, the terms “first” and “second” are used for descriptive purposes only and should not be understood as indicating or implying relative importance. Furthermore, the term “plurality” means two or more, unless otherwise specifically defined.

In the present application, unless otherwise specified and limited, terms such as “installation”, “connection”, and “fixation” should be understood in a broad sense. For example, it can be a fixed connection, a detachable connection, an integration, a mechanical connection, an electrical connection, a direct connection or indirect connection through an intermediary, and an internal communication of two components or the interaction relationship between two components. Those of ordinary skill in the art can understand the specific meanings of the above terms in the present application according to specific situations.

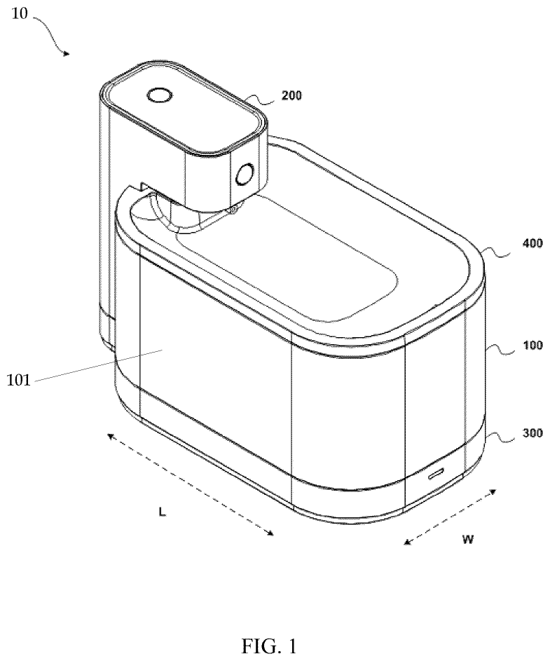

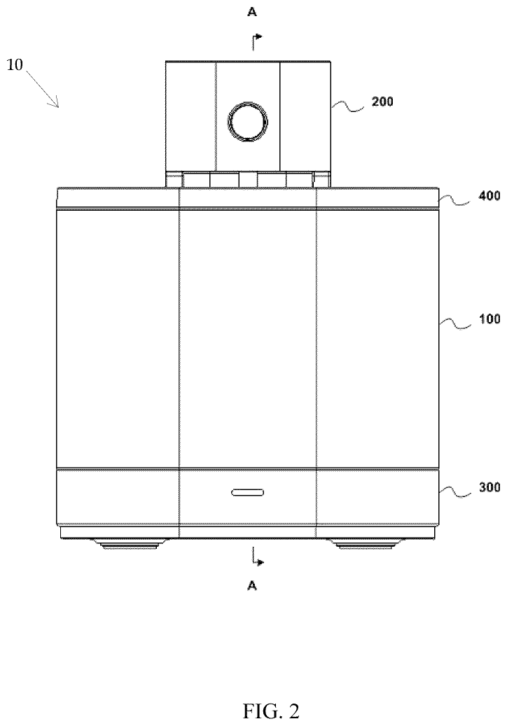

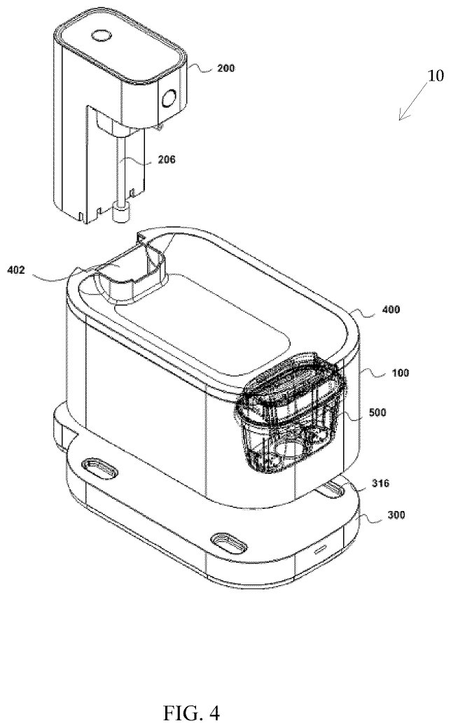

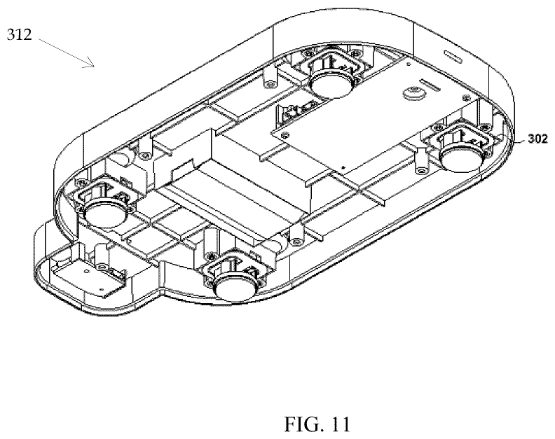

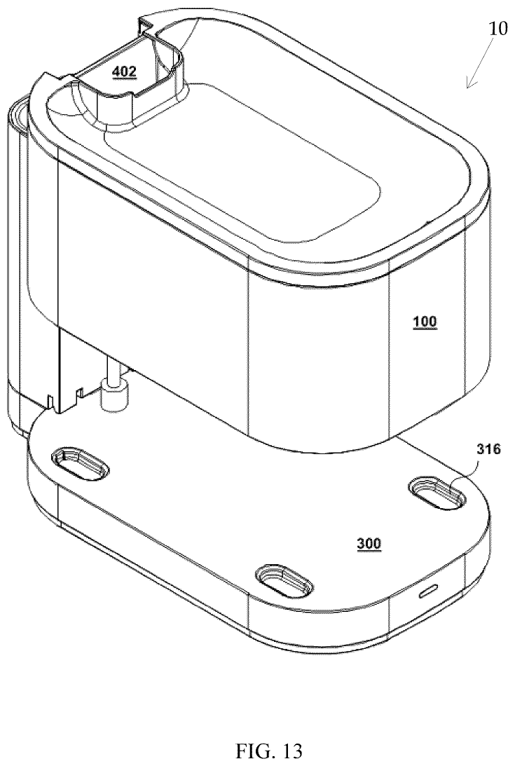

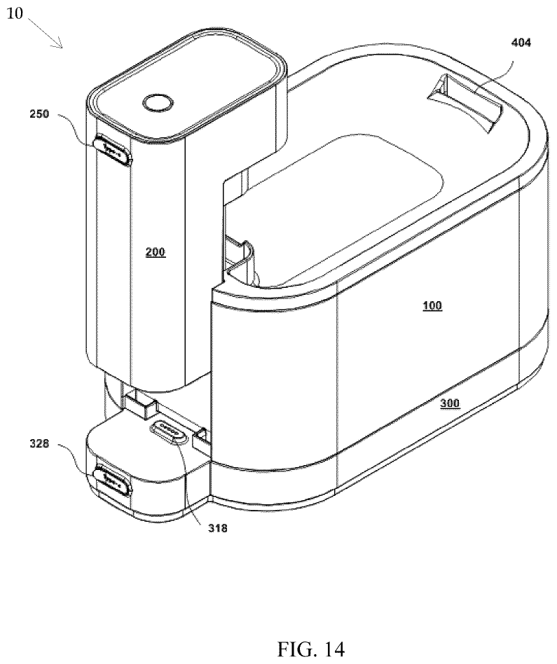

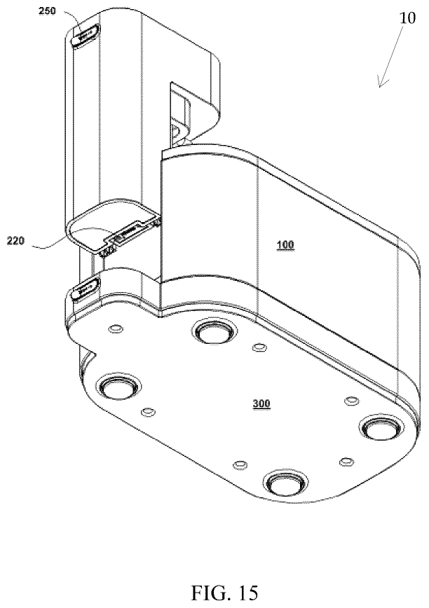

FIGS. 1-17 illustrate an embodiment of a pet water dispenser 10. Referring to FIG. 1, the pet water dispenser 10 includes a water tank assembly 100, a water pumping assembly 200, a base 300, and a filter element or assembly 500 (FIG. 4). The water tank assembly 100 can be configured in a variety of ways. In the illustrated embodiment, the water tank assembly 100 includes a tank body 101 and a drinking tray 400.

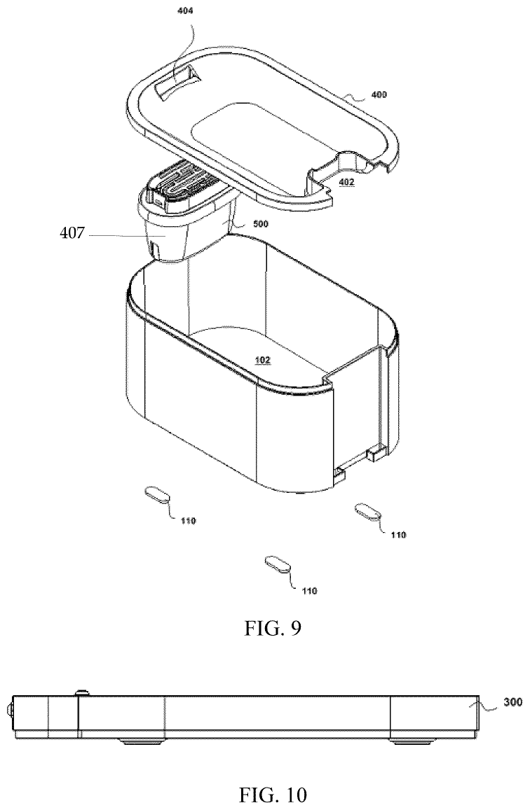

In some embodiments, the tank body 101 is configured in a substantially cuboid shape. In other implementations, however, the tank body 101 can be any suitable shape, such as a cube shape, oval shape, etc. An interior space 102 (e.g., cavity, chamber, etc.) for storing pet drinking water is formed inside the tank body 101. In a preferred embodiment, the volume of the tank body 101 can roughly meet the drinking water volume of small pets (such as cats, dogs, etc.) for 24 hours to 72 hours. The volume of the tank body 101 can also be designed as other volumes according to usage requirements. As shown in FIG. 9, the interior space 102 can be open at the top. The drinking tray 400 is detachably arranged above the interior space 102, and the drinking tray 400 can cover the open top of the interior space 102 to prevent foreign matter from entering the interior space 102.

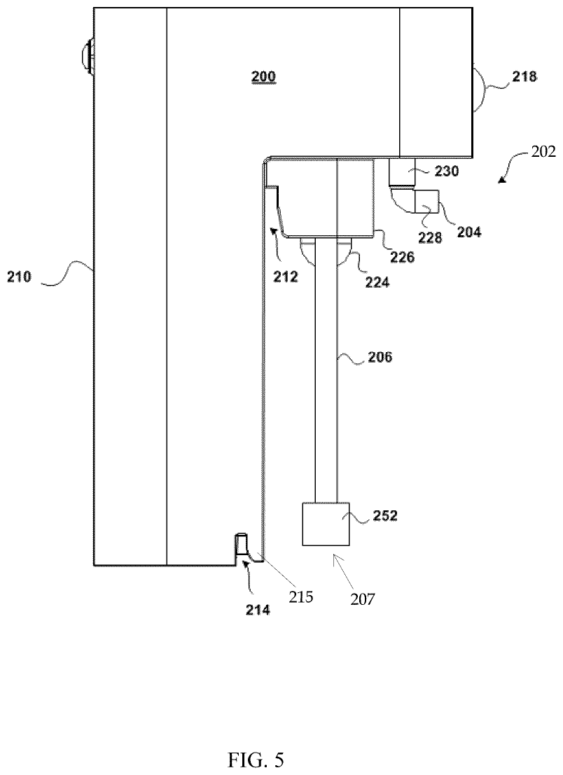

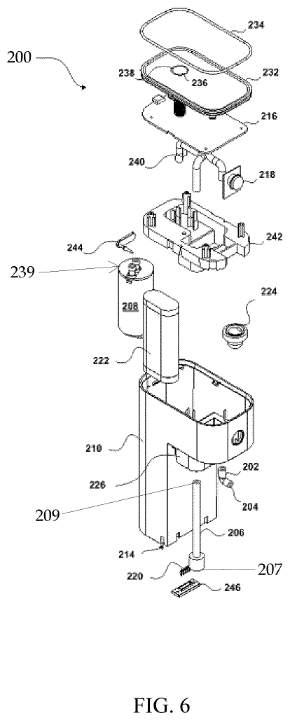

In some embodiments, the water pumping assembly 200 is detachably attached on one side of the tank body 101. Referring to FIGS. 5-6, the water pumping assembly 200 can include a water inlet conduit 206 (e.g., pipe, tube, passage, etc.), a water pump 208, and a water outlet conduit 202 (e.g., pipe, tube, passage, etc.). The water inlet conduit 206 extends into the interior space 102 through a communication port 402 (FIG. 4) formed on the drinking tray 400. The water inlet conduit 206 includes a water inlet port 207 and a water outlet port 209. In some embodiments, the water inlet port 207 is positioned at or near a bottom wall 116 in the interior space 102 of the tank body 101. The water outlet conduit 202 includes a water inlet port and a water outlet port 204. In some embodiments, the water outlet port 204 of the water outlet conduit 202 is positioned in the drinking tray 400 above the interior space 102.

The water pump 208 can be any suitable water pump. In the illustrated implementation, the water inlet conduit 206 is connected to a water inlet end of the water pump 208 and the water outlet conduit 202 is connected to the water outlet end of the water pump 208. The water pump 208 is used to deliver drinking water accumulated in the interior space 102 to the drinking tray 400 through the water inlet conduit 206 and the water outlet conduit 202.

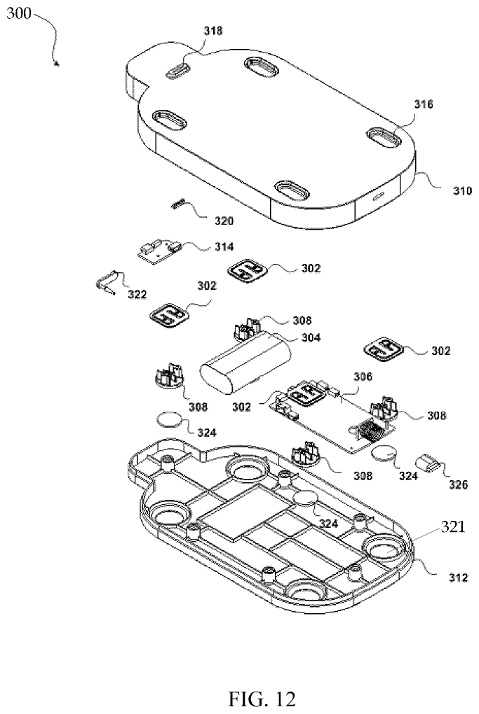

As shown in FIG. 1, a base 300 is provided below the tank body 101. One or more load cells 302 can be disposed in the base 300, as shown in FIG. 12. The one or more load cells 302 are used to detect the remaining water volume of the pet water dispenser 10 in real time. In some embodiments, the water pumping assembly 200 can be detachably connected to the base 300. The load cells 302 can detect the remaining water in the device, accurately record the amount of drinking water, and output the drinking water data.

In some embodiments, the water tank assembly 100, the water pumping assembly 200, the base 300, and the drinking tray 400 are independent of each other and are fixedly connected to each other in a detachable manner. Thus, each component can be independently cleaned to ensure clean drinking water for pets. In some embodiments, no electrical components are installed in the water tank assembly 100 and the drinking tray 400, which effectively avoids damage to electrical components during the cleaning and drying process and prolongs the service life of the product.

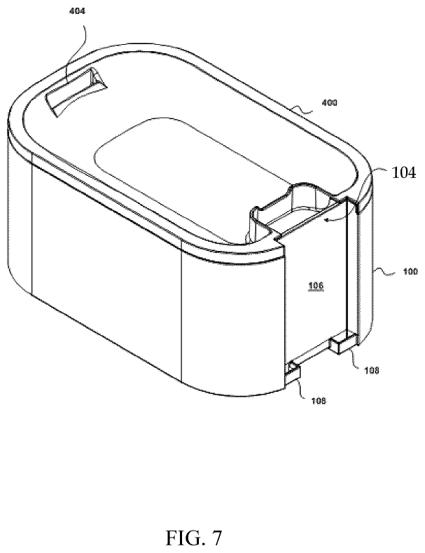

Referring to FIGS. 1-7, the water tank assembly 100, in the length direction (shown by the arrow L in FIG. 1), has the end opposite from the communication port 402 of the drinking tray 400 that adopts an overall simple, smooth, aesthetically pleasing appearance, which is relatively close to the side of the pet when in use. On the end of the tank body 101, close to the communication port 402 of the drinking tray 400, a side wall 106 (FIG. 7) of the tank body 101 is partially recessed toward the communication port 402 and an upper edge of the recessed side wall 106 forms a first connection portion 104 for the water pumping assembly 200.

In some embodiments, one or more second connecting portions 108 are provided to connect the water pumping assembly 200 to the tank body 101. In the illustrated embodiment, a pair of second connecting portions 108 are symmetrically provided at the bottom end corners of the recessed side wall 106. The second connecting portions can be configured in a variety of ways. In the illustrated embodiment, the second connecting portion 108 are vertical channels formed by L-shaped connecting end plates and the recessed side wall 106.

In some embodiments of the water pumping assembly 200, the water pump 208 is installed in a housing 210. As shown in FIGS. 4-6, the housing 210 has an L-shaped main body and an extension portion 226 fitted configured to be received in the communication port 402. The water inlet conduit 206 vertically extends downward from the extension portion 226.

The water pumping assembly 200 can detachably connect to the tank body 101 is a variety of ways. In the illustrated embodiment, the water pumping assembly 200 attaches to the tank body 101 at two positions. The housing 210 is provided with one or more first mounting slots 212 and one or more second mounting slots 214. In the illustrated embodiment, the one or more first mounting slots 212 extend in the same direction (e.g., vertically) as the one or more second mounting slots 214. As shown in FIG. 5, one or more first mounting slots 212 is formed between the main body of the housing 210 and the extension portion 226. In the illustrated example, a single first mounting slot 212 is provided. The first mounting slot 212 is closed at the top end and open at the bottom end of the slot. In the illustrated embodiment, the one or more second mounting slots 214 are a plurality of second mounting slots 214 arranged symmetrically in groups at two at the bottom corners of the housing 210 to form a corner projection 215 therebetween. Each of the second mounting slots 214 is closed at the top end and open at the bottom end of the slot.

To attach the water pumping assembly 200 to the tank body 101, the first connecting portion 104 is received into the first mounting slot 212 (i.e., the upper end of the recessed side wall 106 extends between the main body of the housing 210 and the extension portion 226). In addition, the two second connecting portions 108 are received into the second mounting slots 214 (i.e., the L-shaped connecting end plate extends into the second mounting slots 214, and the corner projection 215 extends into the second connecting portions 108). The above-described mounting structure allows the user attach and detach the water pumping assembly 200 while the connection positions are roughly distributed in a triangle, which has better connection stability.

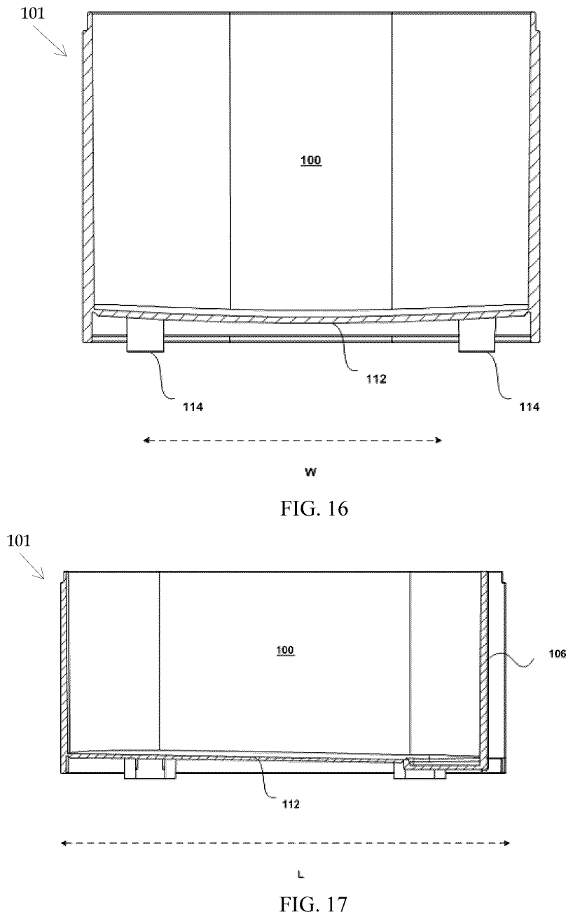

Referring to FIGS. 16-17, in some embodiments, a bottom surface 112 of the interior space 102 formed in the tank body 101 has a downwardly protruding arc shape in the width direction (as shown by the arrow W in the FIG. 16) (i.e., the middle is lower than the two ends). In some embodiments, the bottom surface 112, from the end far away from the communication port 402, is inclined from high to low (i.e., the water depth at the end of the interior space 102 close to the communication port 402 is deepest). In some embodiments, the water inlet port 207 of the water inlet conduit 206 is located at the bottom surface 112 of the interior space 102 where the water is deepest. Thus, the water pump 208 can fully transport the water in the interior space 102, and the drinking water in the interior space 102 can be fully utilized, avoiding water waste. In some embodiments, the inclination angle of the bottom surface 112 of the interior space 102 is less than 10°.

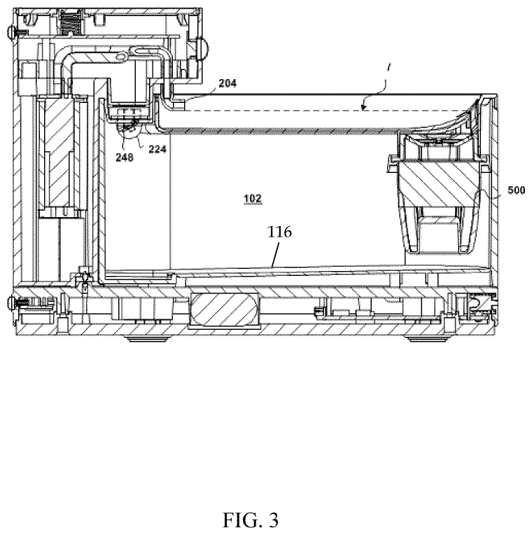

Referring to FIG. 3 and FIG. 5, in some embodiments, the water outlet conduit 202 is L-shaped and includes a vertical pipe section 230 and a horizontal pipe section 228 extending in the same direction as the drinking tray 400. The water outlet port 204 of the water outlet conduit 202 is arranged at the end of the horizontal pipe section 228. During use, the water outlet port 204 of the water outlet conduit 202 just contacts the water surface 1 of the drinking tray 400, which can reduce the noise generated by the water flow when the water is discharged.

Referring to FIGS. 16-17, in some embodiments, a plurality of legs 114 are provided below the water tank assembly 100. In some embodiments, corresponding to the cuboid shape of the tank body 101, four legs 114 are provided, which are respectively positioned at the corners of the tank body 101. A protection pad 110 (e.g., silicone or other suitable material) can be disposed on a lower surface of each of the legs 114. As shown in FIG. 4, a plurality of recesses 316 are provided on an upper surface the base 300 at corresponding positions relative to the legs 114 and are configured for each recess 316 to receive a corresponding leg 114. When the tank body 101 is mounted on the base 300, the side wall of the tank body 101 is flush with the side wall of the base 300. In the illustrated embodiment, there is no additional connecting means between the base 300 and the water tank assembly 100, so the water tank assembly 100 can be easily removed from the base 300. The matching design of the legs 114 and the recesses 316 can also prevent the water tank assembly 100 from being knocked over by pets during use, causing water leakage.

The pet water dispenser 10 is provided with one or more water cleaning means (e.g., filtering, sterilization, etc.). In some embodiments, the pet water dispenser 10 is provided with at least two water cleaning means. Referring to FIGS. 3 and 5, the water pumping assembly 200 can include an ultraviolet lamp 224. Any suitable ultraviolet lamp 224 can be used. The ultraviolet lamp 224 can be positioned on the water pumping assembly 200 to direct ultraviolet light onto the water in the interior space 102. For example, the ultraviolet lamp 224 can be mounted on, adjacent, or proximate the extension portion 226, which extends into the interior space 102 through the communication port 402 formed on the drinking tray 400. The ultraviolet lamp 224 can include a casing and an incident end surface 248 disposed in the casing. The incident end surface 248 is provided with ultraviolet lamp bulbs or beads. The incident end surface 248 is inclined towards the interior space 102, so that the irradiation range of the ultraviolet lamp 224 covers, the majority of, most of, or the entire the interior space 102.

In some embodiments, the filter assembly 500 can be provided in conjunction with another means for cleaning the water (e.g., the ultraviolet lamp 224) or as a sole means for cleaning the water. In some embodiments, the filter assembly 500 is provided in the water tank assembly 100 for purifying and filtering water flowing back into the interior space 102 from the drinking tray 400. In some embodiments, a cleaning means (e.g., filter, UV lamp, or other sterilizing or filtering device, etc.) can be associate with the water inlet port 207 of the water inlet conduit 206. The cleaning means associated with the water inlet port 207 of the water inlet conduit 206 can be incorporated in the pet water dispenser 10 in conjunction with other cleaning means, such as the ultraviolet lamp 224 and/or the filter assembly 500. In some embodiments, the cleaning means associated with the water inlet port 207 of the water inlet conduit 206 includes a water filter 252 arranged at the water inlet port 207 such that water from the interior space 102 being drawn into the water inlet conduit 206 flows through the water filter 252. In some embodiments, the filter assembly 500 is replaceable and detachably arranged on the drinking tray 400.

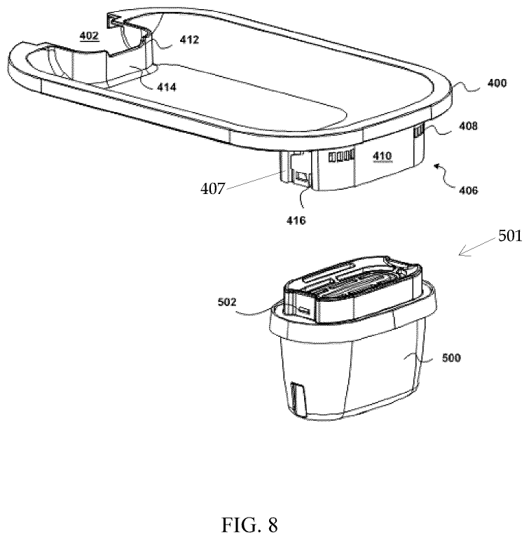

In some embodiments, as shown in FIGS. 8-9, the drinking tray 400 has a generally flat shape with a recessed upper surface having a certain water storage capacity such that pets can drink from the water in the drinking tray 400. As mentioned above, a first end of the drinking tray 400 defines the communication port 402. A second end of the drinking tray 400, opposite the communication port 402, forms a water return port 404. In some embodiments, the water return port 404 is lower, or partially lower, than the water outlet port 204 of the water outlet conduit 202. In some embodiments, to reduce the noise associate with adding water to the water in the drinking tray 400, the water return port 404 is configured such that the horizontal pipe section 228 of the water outlet conduit 202 and the water outlet port 204 are slightly higher than the water surface 1, or that the bottom of the horizontal pipe section 228 touches the water surface 1.

In some embodiments, the filter assembly or element 500 is disposed below the water return port 404. As shown in FIG. 8, the drinking tray 400 has a filter connecting portion 406 extending downward (i.e., toward the interior space 102) below the water return port 404. The filter connecting portion 406 is used for detachably and fixedly connecting the filter assembly 500 to the drinking tray 400. The filter assembly 500 can include any suitable filtering material or filtering element. In some embodiments, the filter assembly 500 includes resin and/or an activated carbon filter element. In some embodiments, suitable filtering material or filtering element is replaceable.

The filter assembly 500 can be configured in a variety of ways. In the illustrated embodiment, the filter assembly 500 has a water inlet portion 501 configured in a cross-sectional shape of an oval or oblong. In other embodiments, however, the water inlet portion 501 can be any suitable shape. The filter connection portion 406 is configured to have a complementary shape to the water inlet portion 501. In some embodiments, the filter connection portion 406 has a pair of side walls 407 and an end wall 410 between the side walls 407. In some embodiments, each of the side walls 407 of the filter connection portion 406 includes a recess or hole 416. The recess or hole 416 can cooperate with the connector 502 (e.g., buckle, snap, tab, detent, etc.) of the water inlet portion 501 of the filter assembly 500 to detachably connect the filter assembly 500 to the drinking tray 400. In some embodiments, the connector 502 is configured to snap-fit with the drinking tray 400.

In some embodiments, a water inlet portion 501 of the filter assembly 500 is configured to be received into the filter connection portion 406, so that the water inlet portion 501 is positioned just below the water return port 404. In some embodiments, the cross-sectional area of the water inlet portion 501 of the filter assembly 500 is much larger than the cross-sectional area of the water return port 404. Thus, water flowing through the water return port 404 will enter the water inlet portion 501 of the filter assembly 500 to fully filter water returning to the interior space 102.

The drinking tray 400 can include one or more overflow ports to prevent water from leaking from the drinking tray 400. In some embodiments, the end wall 410 of the filter connection portion 406 is provided with a plurality of overflow ports 408. The overflow ports 408 can be configured in a variety of ways, such as a small opening or hole. In the illustrated embodiment, a plurality of overflow ports 408 are evenly distributed on both sides of the end wall 410 of the filter connection portion 406. For example, as shown in FIG. 8, four overflow ports 408 are positioned on each side sides of the end wall 410.

In some embodiments, the drinking tray 400 includes one or more overflow recesses 412. The one or more overflow recesses 412 can be configured in a variety of ways. In the illustrated embodiment, the overflow recess 412 is configured as an opening on an end wall 414 of the communication port 402. After the water pumping assembly 200 is installed, the overflow recess 412 is jointly surrounded by the extension portion 226 of the housing 210 of the water pumping assembly 200 and end wall 414. In some embodiments, the overflow recess 412 is set higher than the overflow port 408 to provide anti-overflow function at different water levels.

In some embodiments, the water pump 208 is installed in the housing 210 and is respectively connected with the water inlet conduit 206 and the water outlet conduit 202 extending out of the housing 210. In some embodiments, as shown in FIG. 6, the water inlet and the water outlet 239 of the water pump 208 are arranged on an upper end of the water pump 208 and are respectively connected to the water inlet conduit 206 and the water outlet conduit 202 through the conduit connector 240. The conduit connector 240 can be configured in a variety of ways. In the illustrated embodiment, the conduit connector 240 is branched into at least four openings which can have different distances to keep the water outlet conduit 202 and the water inlet conduit 206 in ideal usage positions.

In some embodiments, the water pump 208 can be activated and deactivated (i.e., water flow started and stopped) by induction control. For example, an inductive sensor 218 can be disposed on the housing 210 of the water pumping assembly 200. The inductive sensor 218 can be configured to generate a pet detection signal when a pet is detected within a set range nearby. The inductive sensor 218 can be any suitable inductive sensor, such as for example, an infrared sensor, a radar sensor, or other suitable inductive sensors. The inductive sensor 218 is a mature technology in the prior art, and its principle will not be described here. In some embodiments, the inductive sensor 218 is disposed above the water outlet conduit 202 on the front of the housing 210 of the water pumping assembly 200.

In some embodiments, the water pumping assembly 200 is also provided with controller, such as a main control chip. The controller can be configured to receive the pet detection signal generated by the inductive sensor 218 and generate a driving signal to drive the water pump 208 to act. The controller can be any suitable controller, such as for example, a single-chip microcomputer chip or other MCU chips. In some embodiments, the controller has multiple input/output interfaces, such as for example, serial communication interfaces, connected to the inductive sensor 218 and the water pump 208. The controller can also have a communication interface. In some embodiments, the communication interface can support different wireless communication protocols, such as WiFi, Bluetooth communication, near-field communication, etc. Thus, the controller can communicate with other electronic devices to output the working status of the pet water dispenser 10. For example, the working status can be displayed through different interfaces associated with the water dispenser 10.

In some embodiments, the controller can be a main control chip integrated on a first main board 216 (FIG. 6). In some embodiments, first main board 216 can be integrated with a power management chip, a voltage stabilizing chip, and the like. The first main board 216 can be fixed on a first main board bracket 242 to keep the first main board 216 stable and working correctly.

In some embodiments, the housing 210 of the water pumping assembly 200 further includes an upper cover 232 and a sealing ring 234 that is provided between the upper cover 232 and the housing 210 to improve the watertight performance of the water pumping assembly 200. A switch button 236 or other suitable actuator, can be associated with the water dispenser 10. In some embodiments, the switch button 236 is disposed on the upper cover 232. In some embodiments, the switch button 236 can be a mechanical button (FIG. 6). In other embodiments, however, the switch button 236 can be a membrane button, a touch button, or other suitable actuator. In some embodiments, an indicator light 238 is arranged around the switch button 236.

In some embodiments, the water pumping assembly 200 can include a first battery 222 that is used to supply power to the water pumping assembly 200 (e.g., to supply power to the water pump 208, the controller, and the inductive sensor 218). In some embodiments, the first battery 222 can also provide power to the base 300. In some embodiments, the first battery 222 can be a rechargeable battery and the water pumping assembly 200 can include a first charging interface 250 is provided on the housing 210. In some embodiments, a waterproof silicone plug 244 is provided for the first charging interface 250. In some embodiments, the water pumping assembly 200 can be charged independently from the base 300.

As shown in FIGS. 13-15, in some embodiments, the water pumping assembly 200 and the base 300 are communicatively connected. One of the water pumping assembly 200 and the base 300 can be provided with a terminal (e.g., a pogo pin) and the other with a communication interface. The terminals and interface can be configured in a variety of ways. For example, in some embodiments, a pogo pin 220 is provided at a lower end of the housing 210 of the water pumping assembly 200. The communication interface 320 matching the pogo pin 220 can be provided at a corresponding position on the base 300. The pogo pin 220 and the communication interface 320 can be placed in contact with each other to establish a communication connection. In some embodiments, the pogo pin 220 is fixed by the terminal cover 246.

With the water pumping assembly 200 and the base 300 communicatively connected, the controller can receive the weighing detection signal generated by the load cell 302 and output the water volume information through the communication interface 320 and displayed through different interfaces associated with the water dispenser 10. For example, in some embodiments the interfaces associated with one or more electronic devices communicatively connected to the controller. In some embodiments, an interface may also be provided on the water dispenser 10, such as for example, at the lower end of the housing 210 of the water pumping assembly 200.

Referring to FIGS. 10-12, in some embodiments, the base 300 can includes a tray 310 and a chassis 312. The tray 310 and the chassis 312 can be connected by fasteners (e.g., bolts). In some embodiments, an interface holder 318 is integrated on the tray 310. In the illustrated embodiment, the base 300 includes four load cells 302. In other embodiments, more or less than four load cells 302 may be used. The four load cells 302 are respectively arranged at four corners of the chassis 312 to accurately measure the total weight of the water tank assembly 100 and the drinking tray 400. In the illustrated embodiment, the load cells 302 are respectively fixed by brackets 308 that are received in respective installation recesses 321 formed in the base 300. In some embodiments, the bottom of the base 300 can include silicone protection pads 324, which increases friction and make the water dispenser 10 more stable during use while also protecting the chassis 312 from wear and tear.

In some embodiments, the base 300 includes a second battery 304 that supplies power to the base 300 (e.g., supply power to the load cells 302). In some embodiments, the second battery 304 is rechargeable. In some embodiments, the base 300 can be charged independent from the water pumping assembly 200. For example, a second charging interface 328 can be provided on the base 300. In some embodiments, a charging interface waterproof plug 322 is provided at the second charging interface 328. The charging interface waterproof plug 322 can be made of any suitable material, such as for example, silica gel. In some embodiments, the base 300 is further provided with a second main board 306 and a power chip 314 is integrated on the second main board 306 to realize charging and discharging of the second battery 304.

In some embodiments, one of the first battery 222 and the second battery 304 can provide power for the water pumping assembly 200 and the chassis 312 at the same time. For example, of the first battery 222 and the second battery 304, the battery with the higher voltage can be used. In some embodiments, both batteries can supply power to the water pumping assembly 200 and the chassis 312 at the same time. The configuration of dual batteries can prolong the use time of a single charge of the water dispenser 10.

In some embodiments, the base 300 is provided with a WIFI indicator light 326. A touch button or other actuator can be selectively set at the WIFI indicator light 326 for resetting the distribution network. The WIFI indicator light 326 can choose one to display the distribution network status or the battery power. For example, in some embodiments, a white light can indicate the distribution network status. A constant white light indicates that the network distribution is successful while a blinking white light indicates that the network distribution is not successful. Similarly, a green light can indicate battery power. A constant green light indicates that the battery power is sufficient while a blinking green light indicates that the battery is charging.

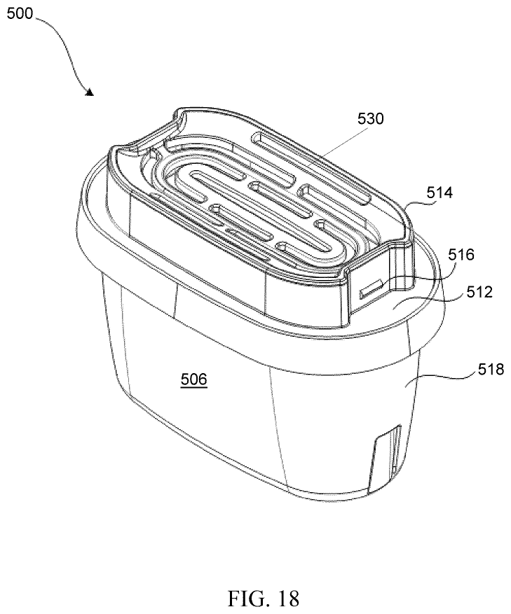

FIGS. 18-21 illustrate an example of the filter element or assembly 500. The filter element or assembly 500 can be configured in a variety of ways. In the illustrated example, the filter assembly 500 includes an end cover or cap 512 and a filter housing 518 that forms a cavity (not shown) inside the filter housing 518. In some embodiments, a filtering material or filtering element (not shown) for filtering water is disposed in the cavity (not shown). The filtering material or element can be selected from any suitable filtering material, such as, but not limited to, resin, activated carbon, or other known filtering materials.

In some embodiments, the filter housing 518 is designed as a cuboid-like shape with arc chamfering design. In other embodiments, however, the filter housing 518 can be any suitable shape. In some embodiments, the size of the filter housing 518 is adapted to the size of the water tank assembly 100 in the water dispenser 10. For example, in some embodiments, the size of the filter housing 518 is approximately the same as the water tank assembly 100 (as shown fin FIGS. 4 and 9) with a width of the filter housing 518 being consistent with, or slightly smaller, than the width of the water tank assembly 100.

The end cover 512 can be connected to the filter housing 518. The end cover 512 can connect to the filter housing 518 by any suitable means (e.g., welding, an adhesive, snap fit, threaded coupling, interference fit, etc.). In some embodiments, the end cover 512 is fixedly connected to the filter housing 518 by ultrasonic welding to ensure that as an independent component, the filter assembly 500 will not leak.

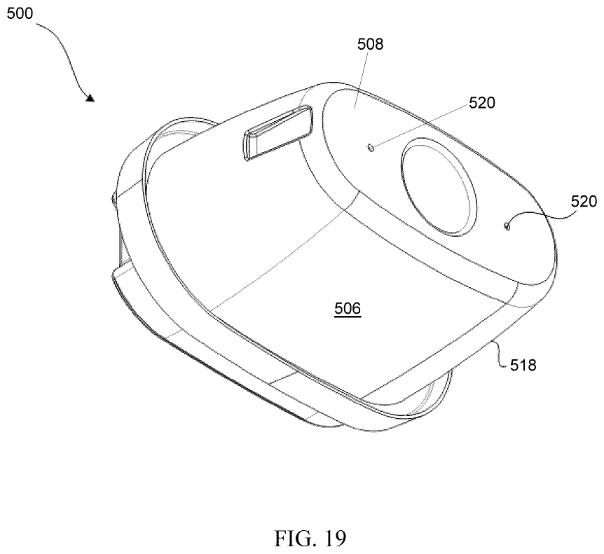

In some embodiments, the filter housing 518 includes one or more side walls 506 and a bottom wall 508 that define the cavity (not shown). The filter housing 518 can include one or more water outlet openings 520. The one or more water outlet openings 520 can be configured in a variety of ways, including shape, sized, location, and number of openings. In some embodiments, the one or more water outlet openings 520 can be positioned on the bottom wall 508, as shown in FIG. 19. In other embodiments, however, one or more of the water outlet openings 520 can be positioned other than on the bottom wall 508 (e.g., on one or more of the side walls 506).

Each of the one or more water outlet openings 520 can be an independent opening extending through bottom wall 508. In some embodiments, the one or more water outlet openings 520 can be centered on the bottom wall 508 of the filter housing 518. In some embodiments, the one or more water outlet openings 520 can be a plurality of strip-shaped openings 520 distributed in an array. In some embodiments, the one or more water outlet openings 520 can be meshed or screened openings.

In some embodiments, the end cover 512 is configured such that a portion of the end cover 512 extends in a direction opposite the bottom wall 508 (e.g., extends vertically upward). For example, in the illustrated example, the end cover 512 includes a mounting portion 514 that extends away from the bottom wall 508 and is configured to attach to the filter connecting portion 406 of the drinking tray 400 (FIG. 8). The mounting portion 514 can attach to the drinking tray 400 in any suitable manner. In some embodiments, the mounting portion 514 is provided with one or more connectors 516 (e.g., buckle, snap, tab, detent, etc.) that are configured to engage a corresponding connecting portion 534 to releasably attach the end cover 512 to the drinking tray 400.

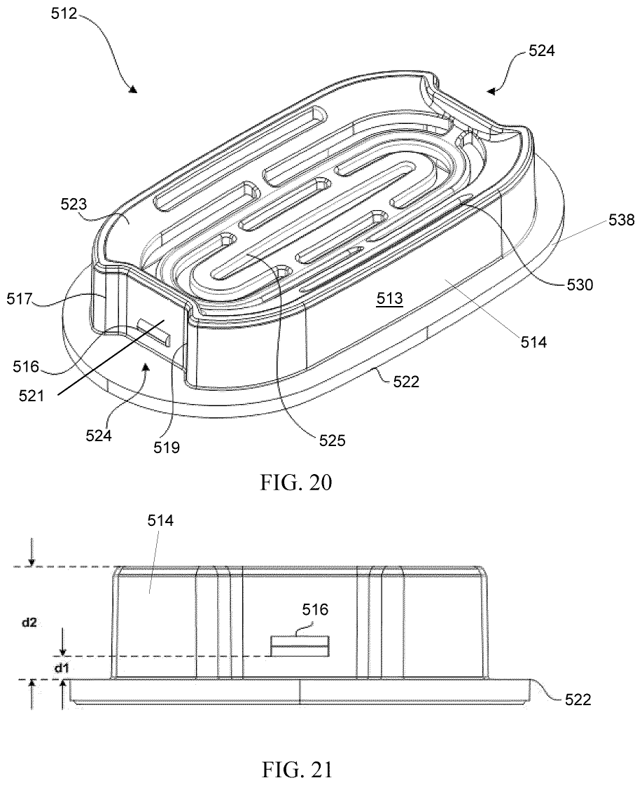

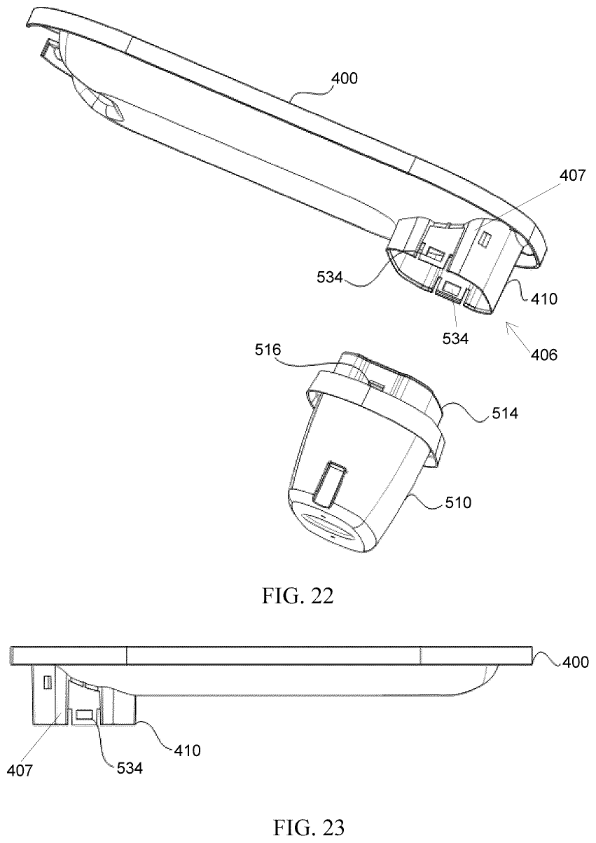

In the illustrated embodiment, the connectors 516 are configured as projections (e.g., a ridge) and the connecting portion 534 of the drinking tray 400 is configured as a recess, groove, or opening. In some embodiments, for the convenience of installation, the connector 516 is designed in a strip shape with an arc-shaped outer edge, as shown in FIGS. 20-21. When the filter assembly 500 is in an installed or attached state with the drinking tray 400, the mounting portion 514 is at least partially received in the filter connecting portion 406 of the drinking tray 400 (FIGS. 8 and 22) and the filter assembly 500 is detachably and fixedly connected to the drinking tray 400 through the connector 516 and connecting portion 534. Thus, the design of the connector 516 and the connecting portion 534 can facilitate the user to disassemble and assemble the filter assembly 500 from the drinking tray 400 and realize the independent replacement of the filter assembly 500. Further, when the filter assembly 500 is in the installed state, a good seal is formed between filter assembly 500 and the drinking tray 400 to ensure that water does not overflow from the edge of the filter assembly 500.

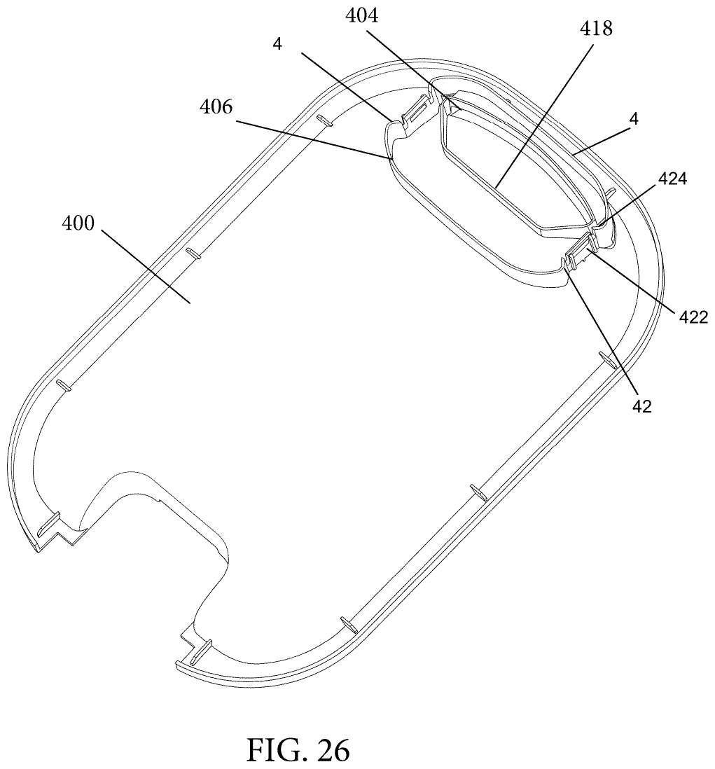

Referring to FIGS. 4, 8, and 22-24, in some embodiments, the filter connecting portion 406 of the drinking tray 400 is designed to match shape of the mounting portion 514 of the filter assembly 500. The drinking tray 400 is provided with the water return port 404 that communicates with the interior space 102 of water tank assembly 100. Thus, water flow can be delivered into the drinking tray 400 from one side of the drinking tray 400 and returned to the interior space 102 of water tank assembly 100 via the water return port 404 of the drinking tray 400 to prevent overflow of water from the drinking tray 400 while realizing the recycling of water. In some embodiments, such as the embodiment shown in FIG. 26, a guide wall 418 can extend from the drinking tray 400 within the filter connecting portion 406 to direct water exiting from the water return port 404 into the filter and prevent unfiltered water from flowing into the water tank and mixing with the filtered water. In FIG. 26, the guide wall 418 is disposed between the water return port 404 and the filter connecting portion 406 and surrounds the water return port 404. The guide wall 418 includes an arcuate wall, a substantially flat wall, and a pair of side walls extending between the arcuate wall and the substantially flat wall. The arcuate wall has a length that is longer than the substantially flat wall. However, other shapes and forms of the guide wall 418 are possible and contemplated.

The side walls 407 and end walls 410 of the filter connecting portion 406, collectively form a guide wall around the water return port 404 that extends vertically downward. In some embodiments, the side walls 407 and end walls 410 are integrally formed with the drinking tray 400. In the illustrated embodiment, the connecting portions 534 are positioned at the end walls 410. In some embodiments, the length of the end walls 410 is approximately the same as that of the length to the mounting portion 514 and the mounting portion 514 can extend into the filter connecting portion 406 along the inner side of the walls 407, 410.

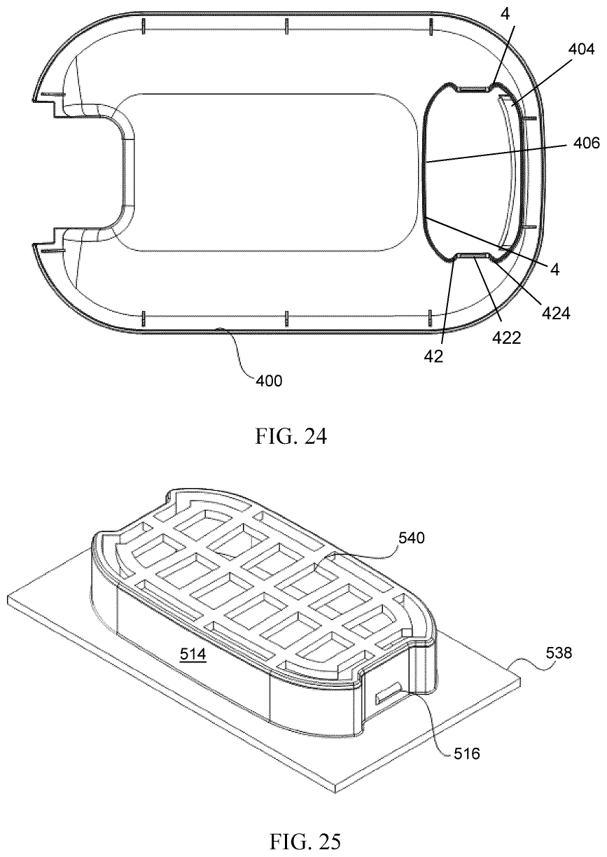

As shown in FIGS. 24 and 26, inner surface of the side walls 407 and end walls 410 of the filter connecting portion 406 is contoured. A cross-section of the filter connecting portion 406 in a horizontal plane is an oval or oval-like (including straight-sided ellipses, i.e., racetrack-shaped). In some embodiments, the side walls 407 are substantially straight, and each of the pair of side walls 407 is positioned between rounded corners and parallel to the other side wall. End walls 410 having a length that is less than a length of the side walls 407 are positioned between adjacent rounded corners, each end wall 410 substantially parallel to the other end wall 410. In some embodiments, both end walls 410 of the filter connecting portion 406 are inwardly recessed (e.g., concave). In some embodiments, the filter connecting portion 406 is symmetric about both a major axis of the filter connecting portion 406 that bisects the end walls 410 and a minor axis of the filter connecting portion 406 that bisects the side walls 407. For example, the filter connecting portion 406 has a generally straight-sided elliptical shape with the end walls 410 perpendicular to the main axis (e.g., long axis) of the filter connecting portion 406 and respectively symmetrically indented or recessed.

In some embodiments, the end walls 410 include a first inclined portion 420, a first planar portion 422, and a second inclined portion 424 sequentially connected such that the first planar portion is positioned between the first inclined portion 420 and the second inclined portion 424. Each of the first inclined portion 420 and the second inclined portion 424 extends upward and away from the first planar portion 422. In some embodiments, an angle between the inner surface of first inclined portion 420 and the inner surface of the first planar portion 422 and an angle between the inner surface of the second inclined portion 424 and the inner surface of the first planar portion 422 are both greater than 90°. Although described herein with respect to “declined portions” and “angles,” it is contemplated that some embodiments can include curved portions which join the end walls 410 to adjacent corners of the filter connecting portion 406. For example, in some embodiments, the corner of the filter connecting portion 406 can transition from a convex curve forming part of the end wall 410. In such embodiments, the first planar portion can be positioned between a first concave surface and a second concave surface.

In some embodiments, the inner surfaces of the walls 407, 410 are sealingly combined with the outer surface of mounting portion 514 to form a seal. The connector 516 extends into the connecting portion 534 for attaching and fixing the filter assembly 500 on the filter connecting portion 406 of the drinking tray 400. The mounting portion 514 closely overlaps with the inner surface of the walls 407, 410 to improve the sealing performance.

The end cover 512 is located below the water return port 404 and covers the water return port 404 to fully direct overflowing water from the drinking tray 400 into the filter assembly 500. In some embodiments, the end cover 512 is provided with a plurality of water inlet holes. The water inlet holes can be configured in a variety of ways, including size, shape, number, orientation, and location. As shown in FIGS. 18 and 20, in some embodiments, the water inlet holes 530 can be designed as a strip (i.e., elongated) hole. In some embodiments, as shown in FIG. 25, one or more of the water inlet holes opened on the end cover 512 may also be rectangular-shaped holes 540.

As shown in FIG. 20, the end cover 512 includes a top surface 523. In some embodiments, the top surface 523 can be a downwardly concave arc shape (i.e., toward the direction of the cavity for accommodating the filter material) and at least one water outlet hole 525 can be located at the bottom of the concave arc shaped top surface 523 (i.e. at the low point), which can effectively prevent the top surface 523 of the end cover 512 from accumulating water, further reducing the risk of water leakage.

In some embodiments, the end cover 512 can include an end cap body portion 522. The end cap body portion 522 can be configured in a variety of ways. In the illustrated embodiment, the end cap body portion 522 is shaped as a flat plate with the mounting portion 514 extending vertically upward from the end cap body portion 522. In some embodiments, the mounting portion 514 is tapered as it extends upward from the end cap body portion 522, such that a largest dimension of the mounting portion 514 is positioned adjacent to the end cap body portion 522 and decreases with increasing distance from the end cap body portion 522. In some embodiments, the end cap body portion 522 is partially arranged around the mounting portion 514 and the end cap body portion 522 and the mounting portion 514 are coaxial.

Along the horizontal direction, the cross-sectional area of the mounting portion 514 is slightly smaller than the cross-sectional area of the end cap body portion 522. In this way, the mounting portion 514 includes a water inlet with a sufficient area and the structural strength. Further, when the filter assembly 500 is in the installed state, the end cap body portion 522 can provide a stable installation surface and extends into and is fixably connected to the filter housing 518.

In some embodiments, the mounting portion 514 is contoured, as shown in FIG. 20. In FIG. 20, a cross-section of the mounting portion 514 in a horizontal plane is an oval or oval-like (including straight-sided ellipses, i.e., racetrack-shaped). In some embodiments, the mounting portion 514 has a pair of elongated side walls 513 that are substantially straight, each of the pair of elongated side walls 513 being positioned between rounded corners and parallel to the other elongated side wall. End walls 524 having a length that is less than a length of the side walls 513 are positioned between adjacent rounded corners, each end wall 524 substantially parallel to the other end wall 524, to provide a continuous protrusion from the end cap body portion 522. In some embodiments, both end walls 524 of the mounting portion 514 are inwardly recessed (e.g., concave). In some embodiments, the mounting portion 514 is symmetric about both a major axis of the mounting portion 514 that bisects the end walls 524 and a minor axis of the mounting portion 514 that bisects the side walls 513. As shown in FIG. 20, for example, the mounting portion 514 has a generally straight-sided elliptical shape with the end walls 524 perpendicular to the main axis (e.g., long axis) of the mounting portion 514 and respectively symmetrically indented or recessed. In some embodiments, each end wall 524 includes the connector 516 for attaching the mounting portion 514 to the filter connecting portion 406. In other embodiments, however, the connectors 516 can be positioned at other locations, such as for example, on the two side walls 513 intersecting the minor axis (e.g., short axis) of the mounting portion 514.

In some embodiments, as shown in FIG. 20, the end walls 524 include a first inclined portion 517, a first planar portion 521, and a second inclined portion 519 sequentially connected such that the first planar portion 521 is positioned between the first inclined portion 517 and the second inclined portion 519. Each of the first inclined portion 517 and the second inclined portion 519 extends upward and away from the first planar portion 521. In some embodiments, an angle between the outer surface of first inclined portion 517 and the outer surface of the first planar portion 521 and an angle between the outer surface of the second inclined portion 519 and the outer surface of the first planar portion 521 are both greater than 90°. In the illustrated embodiment, the connector 516 is disposed on the outer surface of the first planar portion 521. Although described herein with respect to “inclined portions” and “angles,” it is contemplated that some embodiments can include curved portions which join the end walls 524 to adjacent corners of the mounting portion 514. For example, in some embodiments, the corner of the mounting portion 514 can transition from a convex curve forming part of the end wall 524. In such embodiments, the first planar portion 521 can be positioned between a first concave surface and a second concave surface.

The outer edge 538 of the end cap body portion 522 can be in a variety of shapes and can be, for example, contoured in a manner similar to the mounting portion 514. In the illustrated embodiment, the outer edge 538 of the end cap body portion 522 has a cross-section in a horizontal plane that is an oval with straight sides (FIG. 20). In other embodiments, the outer edge 538 of the end cap body portion 522 has a cross-section in a horizontal plane that is a rectangle (FIG. 25). In some embodiments, the outer edge 538 of end cap body portion 522 and the filter housing 518 are fixedly connected by ultrasonic welding.

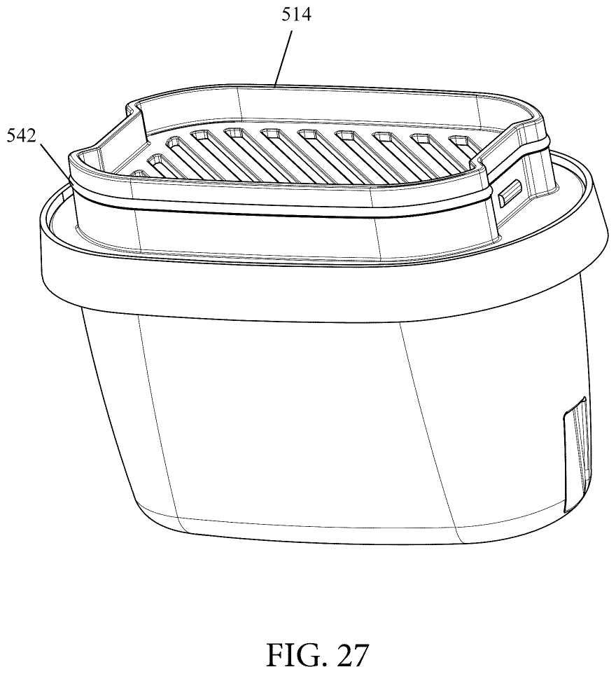

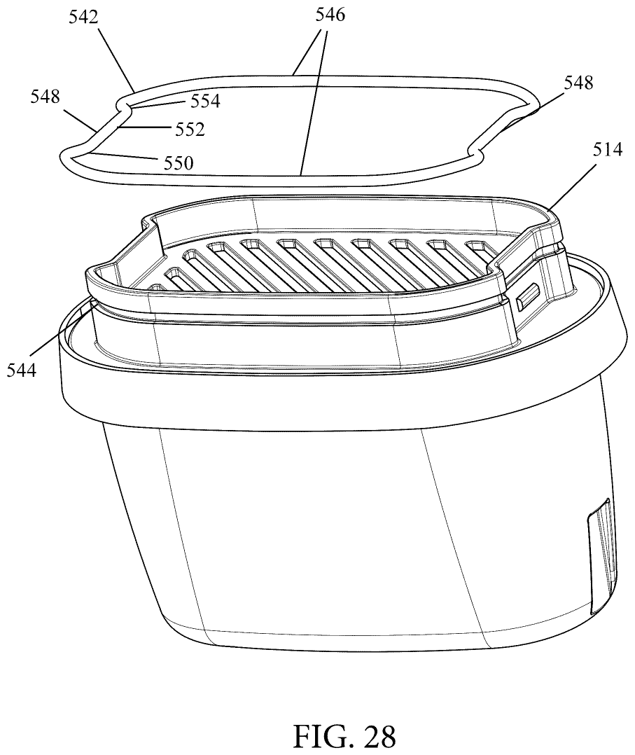

In some embodiments, such as the embodiment shown in FIGS. 27 and 28, the mounting portion 514 has at least one seal 542 disposed around its circumference. Although optional, the seal forms a water-tight seal or improves a seal between the mounting portion 514 of the filter assembly 500 and the filter connecting portion 406 when the filter assembly 500 is received within the filter connecting portion 406. In embodiments including a seal 542, the mounting portion 514 can include a circumferential groove 544 in the outer surface to receive the seal 542 and provide a seating for the seal 542. The seal 542 can be, for example, any type of elastomeric material typically used in water sealing applications. It should be understood that, in some embodiments, the seal 542 has a generally circular shape (e.g., an o-ring) and is configured to conform to the shape of the exterior surface of circumference of the mounting portion 514. Alternatively, in some embodiments, the seal 542 is contoured, as shown in FIG. 28. For example, in some embodiments, the seal 542 has a cross-section in a plane containing the circumference of the seal 542 that is an oval or oval-like (including straight-sided ellipses, i.e., racetrack-shaped). In some embodiments, the seal 542 has a pair of elongated sides 546 that are substantially straight, each of the pair of elongated sides 546 being positioned between rounded corners and parallel to the other elongated side 546. Ends 548 having a length that is less than a length of the elongated sides 546 are positioned between adjacent rounded corners, each end substantially parallel to the other end 548, to provide a continuous surface. In some embodiments, both ends of the seal 542 are inwardly recessed (e.g., concave). In some embodiments, the seal 542 is symmetric about both a major axis of the seal 542 that bisects the ends and a minor axis of the seal 542 that bisects the sides.

In some embodiments, the ends 548 include a first inclined portion 550, a first planar portion 552, and a second inclined portion 554 sequentially connected such that the first planar portion 552 is positioned between the first inclined portion 550 and the second inclined portion 554. Each of the first inclined portion 550 and the second inclined portion 554 extends upward and away from the first planar portion 552. Although described herein with respect to “inclined portions” and “angles,” it is contemplated that some embodiments can include curved portions which join the ends to adjacent corners of the seal.

In some particular embodiments, the seal 542 has an outer surface that is substantially similar to the shape shown in FIG. 28 and an inner surface that has a different shape, such as an oval or an oval-like shape. Accordingly, in such embodiments, the seal 542 can be coupled with a mounting portion having a substantially oval-like shape to create a surface having inwardly recessed end walls, functioning as an adapter to couple a non-conforming mounting portion to a filter connecting portion having recessed end walls, such as the filter connecting portion shown in FIG. 26.

Considering the sealing performance and the stability of the connection structure, in some embodiments, as shown in FIG. 21, the ratio between a height d2 of the mounting portion 514 and a distance from the end cap body portion 522 to the connector 516 is between 0.15 and 0.25. Thus, the connector 516 is arranged near the bottom end of the mounting portion 514. In some embodiments, the distance d1 is about 2.65 mm and the height d2 of the mounting portion 514 is about 13 mm.

While the inventive concepts of the present application have been illustrated by the description of embodiments thereof, it is not the intention of the applicant to restrict or in any way limit the scope of the appended claims to such detail. Therefore, the invention, in its broader aspects, is not limited to the specific details, the representative apparatus, and illustrative examples shown and described. Accordingly, departures can be made from such details without departing from the spirit or scope of the general inventive concepts.

1. A filter assembly for filtering water in a water dispenser, comprising:
an end cover configured to connect with the water dispenser, the end cover including a body portion and a mounting portion protruding from the body portion, wherein the mounting portion is configured to releasably attach to the water dispenser; and
a filter housing assembled with the end cover and comprising a cavity configured to receive a filtering material;
wherein the mounting portion has an oval or oval-like cross-section in a horizontal plane, and both ends of the oval or oval-like cross-section are inwardly recessed.

2. The filter assembly of claim 1, wherein the filter housing further comprises an opening communicating with the cavity, wherein the end cover is arranged at the opening; and
wherein the end cover comprises a water inlet in fluid communication with the cavity, and forms a sealed connection with the filter housing.

3. The filter assembly of claim 1, wherein the mounting portion is configured to be at least partially received within a filter connecting portion of the water dispenser.

4. The filter assembly of claim 1, wherein the end cover includes one or more water inlet openings, and the filter housing includes one or more water outlet openings for receiving water from the one or more water inlet openings.

5. The filter assembly of claim 4, wherein the mounting portion of the end cover includes a top surface and wherein at least one of the water inlet openings is positioned on the top surface.

6. The filter assembly of claim 5, wherein the top surface is concave.

7. The filter assembly of claim 6, wherein at least one of the water inlet openings is positioned at a low point on the concave top surface.

8. The filter assembly of claim 4, wherein the filter housing includes a side wall and a bottom wall and at least one of the water outlet openings is positioned on the bottom wall.

9. The filter assembly of claim 4, wherein the one or more water outlet openings are screened or meshed.

10. The filter assembly of claim 1, wherein the mounting portion includes one or more connectors for releasably attaching to the water dispenser.

11. The filter assembly of claim 10, wherein the one or more connectors are projections configured to be received within corresponding connecting portion on the water dispenser.

12. The filter assembly of claim 1, wherein each of the end walls of the mounting portion includes at least one connector for releasably attaching the end cover to the water dispenser.

13. The filter assembly of claim 1, wherein an angle between an outer surface of the first inclined portion and an outer surface of the planar portion is greater than 90°.

14. The filter assembly of claim 13, wherein the planar portion includes at least one connector for releasably attaching the end cover to the water dispenser.

15. The filter assembly of claim 1, wherein the mounting portion is symmetric about a central axis.

16. The filter assembly of claim 1, further comprising a seal disposed around a circumference of the mounting portion and configured to form a seal when the filter assembly is received within a filter connecting portion of a water dispenser.

17. A filter assembly for filtering water in a water dispenser, comprising:
an end cover configured to connect with the water dispenser, the end cover including a body portion and a mounting portion protruding from the body portion, wherein the mounting portion is configured to releasably couple to the water dispenser;
a filter housing assembled with the end cover forming a cavity for accommodating a filtering material; and
at least one seal having an oval or oval-like cross-section in a horizontal plane, wherein both ends of the oval or oval-like cross-section are inwardly recessed, and wherein the at least one seal is configured to create a water-tight seal between the mounting portion and the water dispenser.

18. A water dispenser comprising:
a tank body defining an interior space for storing water;
a top cover detachably arranged on the tank body above the interior space, the top cover having an upper surface that at least partially defines a drinking tray with a first water return port and a filter connecting portion extending downward below the water return port; and
a filter assembly detachably installed in the interior space, the filter assembly comprising an end cover and a filter housing, the end cover including a body portion and a mounting portion protruding from the body portion, wherein the mounting portion is configured to releasably attach the end cover to the filter connecting portion.

19. The water dispenser according to claim 18, wherein the top cover further comprises a guide wall extending downward from the top cover, wherein the guide wall is disposed between the water return port and the filter connecting portion, and comprises an arcuate wall, a substantially flat wall, and a pair of side walls extending between the arcuate wall and the substantially flat wall.

20. The water dispenser according to claim 18, wherein the filter connecting portion includes a pair of end walls connected by a pair of side walls that are symmetrical and curved, each of the end walls are inwardly recessed and includes a first inclined portion, a planar portion, and a second inclined portion sequentially connected.
